(19) United States
(12) Patent Application Publication
(10) Pub. No.: US 2009/0273718 A1
(43) Pub. Date: Nov. 5, 2009

(54) Remote Control System for Remotely Controlling an Electronic Card Connected to a Television Screen or Monitor and Associated Method for Transmitting Control Signals

(75) Inventors: Alexandre Barbaroux, Plan de Cuques (FR); Paul Luciani, Auriol (FR); Yorick Blanes, Aix-en-Provence (FR); Romain Vignes, Auriol (FR); Maxime Marchet, Marseille (FR); David Servignat, Marseille (FR); Dominique Feral, Ceyreste (FR)

Correspondence Address: BACHMAN & LAPOINTE, P.C., 900 CHAPEL STREET, SUITE 1201, NEW HAVEN, CT, 06510, US

(73) Assignee: WYPLAY, Allauch (FR)

(21) Appl. No.: 12/433,942

(22) Filed: May 1, 2009

(30) Foreign Application Priority Data
May 5, 2008 (FR) 0802443

(51) Int. Cl. H04N 5/44

(52) U.S. Cl. 348/734; 348/E05.096

(57) ABSTRACT

A remote control system is provided for remotely controlling, by the hand of a user, an electronic card connected to a screen (monitor or television). This remote control system includes at least: a keypad, an onboard processor and a system for transmitting signals intended for the electronic card. A method for reproducing the keypad of the remote control system on a zone of reduced size superimposed on the image of the screen is provided. The image of the keypad on the screen displays virtually, and in real time, the position of the thumb of the hand of the user placed on the remote control system. The image of the keypad on the screen, referred to as zone of reduced size, is more preferably located in a corner of the screen in such a way as to not hide the broadcast image. Finally, a method for transmitting control signals using a remote control system controlled by the hand of a user intended for an electronic card connected to a television screen or monitor is provided.

### BACKGROUND

(1) Field of the Invention

This invention relates to:

A remote control system for remotely controlling, by the hand of a user, an electronic card connected to a screen (monitor or television); this remote control system comprising at least one keypad, an onboard processor and a system for transmitting signals intended for said electronic card, and

A method for reproducing the keypad of said remote control system on a zone of reduced size superimposed on the image of the screen; on this image of the keypad on the screen is displayed virtually, and in real time, the position of the finger of the hand of the user placed on the remote control system; this image of the keypad on the screen, called the zone of reduced size, is more preferably located in a corner of the screen in such a way as to not hide the broadcast image.

(2) Prior Art

The remote controls of prior art have a keypad comprising a certain number of keys each corresponding to a function. The user who wants to change the channel, the volume, the color, the contrast etc. must always look at the keypad in order to press a key and have access to its function and must therefore look away from the television screen for a certain period of time, i.e. from a few milliseconds for a fast user to a few seconds for a slow user.

This change can take place in two substantial steps concerning the wish of the user to leave, for example, the current program and to go to the following program:

a step of selecting: the user who is watching a program on a channel and wants to change the channel will take the remote control in his hand; his eyes then look away from the television screen, with the remote control being in his hand and being looked at; his thumb lightly touching said keypad while looking at it in order to look for the key that is going to allow him to switch to the following program:

a step of validating: once the desired key is found on the keypad according to the step hereinabove, the user will press with his thumb on the selected key in order to switch to the program of the desired channel while immediately looking at the screen in order to view the image and confirm for himself that he has correctly performed the step of validating.

In order to be more complete, during the step of selecting, the eye of the user constantly moves between the screen of the television set and the keypad of the remote control in order to press the desired key in order to modify the criteria of functions selected by the user. The user loses the images of the program that are passing on the screen during the time that he spends looking at the keypad to find the required key then pressing the key during the step of validating.

In this case of the use of a remote control, it is indispensable that these steps of selecting and of validating are carried out in daylight or in a lighted visual ambiance since the keypad of the remote control must be looked at at each change.

Generally, the keypads of these remote controls are provided with around fifty keys in order to control all of the features proposed by the electronic device. However, in the majority of cases, only a few keys are required, approximately eight, rendering the forty and a few others little used. Consequently, the perception of the use of the remote control remains complex for the average user who does not know the functionality of said keys.

### SUMMARY OF THE INVENTION

The purpose of this invention is to overcome the disadvantages mentioned hereinabove.

It relates to a remote control system for remotely controlling, by the hand of a user, an electronic card connected to a television screen or a monitor, said remote control system comprising at least one keypad comprising a plurality of keys, an onboard processor, a system for transmitting signals intended for said electronic card, and is characterized in that the keypad comprises a means for detecting and locating the finger of the user placed on said keypad thus making it possible to display on the screen the keypad of the remote control system and the position of the finger. As such, the user no longer looks at the remote control system but only at the screen, consequently losing no image passing on the screen. This remote control system is moreover easy to use in a night-time ambiance since the user looks at the screen only and no longer at the remote control. Finally, the remote control is simple to use for the user since the function of the key appears on the screen; he no longer has to wonder if he were to inadvertently touch a key of which he does not know the function.

Preferentially, the display on the screen of the keypad of the remote control system and of the position of the finger occupies a zone of reduced size superimposed on the image of the screen. Indeed, this zone of reduced size which is going to contain the display of the keypad of the remote control system and of the position of the finger will then be looked at by the user instead of the keypad of the remote control system located in his hand which will be used in his hand but no longer looked at.

According to another embodiment of the invention, the zone of reduced size superimposed on the image of the screen, zone which contains the display of the keypad of the remote control system and of the position of the finger, is positioned in a corner of the screen in such a way as to not hide the broadcast image. As such, the user can see the image on the screen as well as said zone in a simple glance without obstruction.

According to another embodiment of the invention, the keypad further comprises at least one cursor provided with its system of detecting and of locating the finger of the user placed on this said cursor thus making possible the display on the screen of the cursor of the remote control system and of the position of the finger.

The invention also relates to the electronic card which comprises an electronic processor and its associated memory wherein are stored the image of the keypad of the remote control, a virtual image of a finger and pictograms characterizing actions associated with each key, with the whole (the image of the keypad of the remote control, virtual image of a finger and of pictograms) being displayed in a zone of reduced size superimposed on the image of the screen when the user lightly touches the keypad of the remote control. This electronic card is indispensable for the proper operation of the remote control system such as described hereinabove.

Moreover, the electronic card has the capacity to modify the function associated with each key of the remote control and therefore to modify the pictogram superimposed on each key.

Also, the electronic card has the capacity of playing a sound sequence associated with each function when the user lightly touches a key in such a way that sound information supplements the visual information provided by the pictogram. These feature is interesting to use when the user is visually impaired or blind, the information is no longer mentioned in written language called “Braille” on the keys but is auditory for the visually impaired or blind user.

Finally, the invention also relates to a method for transmitting control signals using a remote control system controlled by the hand of a user intended for an electronic card connected to a television screen or monitor, method consisting in:

lightly touching a key of the keypad of the remote control system making it possible for card to display said keypad with its pictograms and the position of the finger of the hand of the user on the lightly touched key, with the whole being then displayed in a zone of reduced size superimposed on the image of the screen;

pressing the finger on the lightly touched key validating the action of the key;

lifting the finger from the keypad making it possible for said card to delete the display of the zone of reduced size superimposed on the image of the screen.

According to another embodiment of the method of the invention, the latter consists in, after lightly touching a key of the keypad of the remote control system, that the user can move his finger towards another key of the keypad, said card thus displaying the movement of the finger towards this new key on the zone of reduced size superimposed on the image of the screen. This embodiment of the method of the invention is interesting when the finger of the user has not found in a single movement the desired key inversely to the option of the preceding paragraph where the user immediately finds the desired key. It is effectively desirable that the finger move on the keypad and appear on the screen until it is positioned on the desired key.

The remote control system, the electronic card and the method of transmitting signals of the invention are particularly useful for the user in mainly three cases described hereinbelow. The user can therefore press on the remote control that he has in his hand without having to look at it since the latter is displayed on the screen of the television set. This allows the user to:

Always keep his eyes fixed on the television since the remote control appears on the screen and not lose anything of the images that pass on the screen;

Facilitate the use of the remote control in a dark environment where it is very difficult to see the keys of the remote control and their associated functions;

Change the functions associated with the keys of the remote control according to what is displayed on the screen as for example a scrollable list, a video, etc.

### BRIEF DESCRIPTION OF THE DRAWINGS

Other advantages and characteristics of the invention shall appear hereinbelow when examining the detailed description of a non-limited implementation method and of the annexed drawings in which:

FIG. 1 is a general schematic view of the television screen and of the reduced zone appearing on the screen according to the invention;

FIG. 2 is a general schematic view of the elements required for the proper operation of the invention;

FIG. 3 is a general schematic view of the remote control system according to the invention.

### DETAILED DESCRIPTION OF THE PREFERRED EMBODIMENT(S)

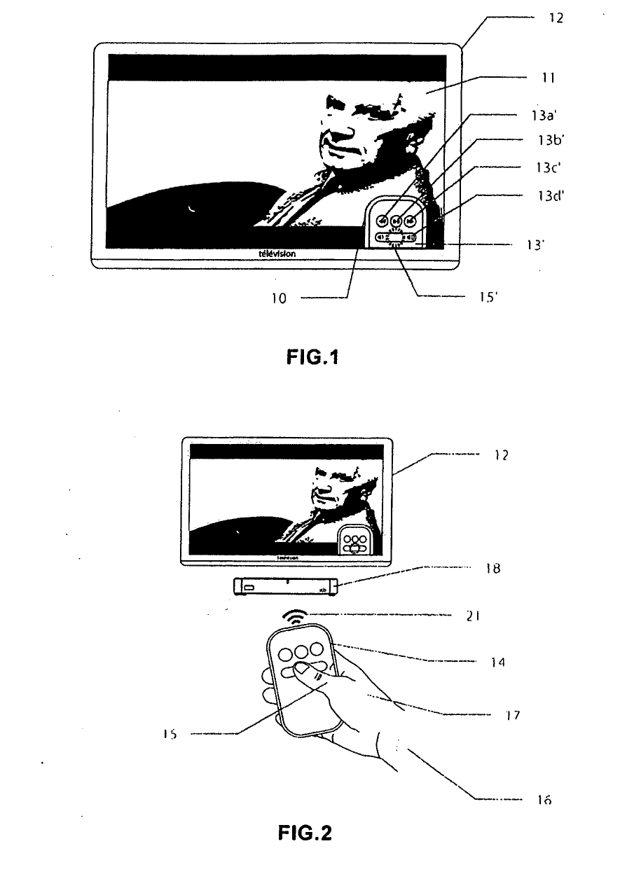

The objective of this invention is to display, according to FIG. 1 in a zone 10, superimposed on the image 11 of the television 12, the keypad 13 of the remote control 14 with the position in real time of the thumb 15 of the user 16 on the latter 13. This zone 10 is of small size, located more preferably in a corner of the image 11 of the television 12, in such a way as to not hide the image 11 of the television 12.

According to FIG. 2, the user 16 can therefore press on the remote control 14 that he has in his hand 17, without having to look at it, since the latter is displayed on the screen. This as such makes it possible:

always keep his eyes fixed on the television 12 (according to FIG. 1),

facilitate the use of the remote control 14 in a dark environment where it is very difficult to see the keys of the remote control 14 and their associated functions,

change the functions associated with the keys of the remote control 14 according to what is displayed on the screen as for example a scrollable list, a video, etc.

The product of the invention according to FIG. 2 is constituted of a remote control 14 and an electronic device 18 connected to a television 12. This device 18 can be a DVD player, satellite receiver, digital recorder, etc., more commonly called by those skilled in the art a “CE Device”.

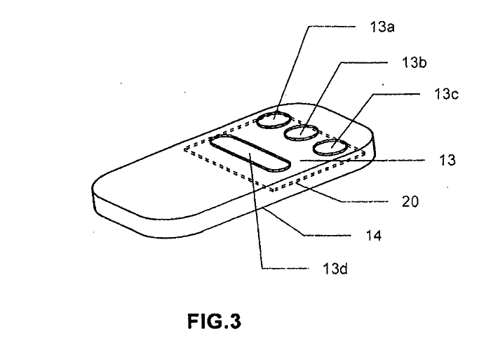

The remote control 14 according to FIG. 3 comprises:

a battery (not shown),

an electronic chip (not shown),

a keypad 13 comprising at least 3 keys, 13a, 13b, 13c and at least one cursor 13d; the keypad 13 is capable of detecting when the thumb lightly touches a key or a cursor; the cursor providing a feature that is complementary to that of the key i.e. a notion of locating the finger on the axis of the cursor,

a means for detecting and locating 20 the thumb 15 of the user 16 placed on said keypad 13 as such making it possible to display on the screen the keypad 13 of the remote control system 14 and the position of the thumb 15,

a transmitter 21 for transmitting towards the “CE Device” 18 the Selection and Validation information,

The “CE Device” 18 such as shown in FIG. 2 is provided with a receiver (compatible with the transmitter of the remote control) and has the capacity of superimposing on the image 11 of the television 12 a zone 10 of small size representing the keys 13a, 13b, 13c and/or cursor 13d of the remote control 14 with the position in real time of the thumb 15 of the user 16 on a key 13a, 13b, 13c, or a cursor 13d. It comprises an electronic processor and its associated memory wherein is stored the image of the keypad 13 of the remote control 14, a virtual image of a thumb 15 and of pictograms 19 (according to FIG. 1) characterizing the actions associated with each key 13a, 13b, 13c, the whole being displayed in a zone 10 of reduced size superimposed on the image 11 of the screen when the user 16 will lightly touch the keypad 13 of the remote control 14.

Moreover, the CE Device 18 has the capacity of playing a sound sequence associated with each function when the user 16 lightly touches a key 13a, 13b, 13c in such a way that sound information supplements the visual information provided by the pictogram 19.

The method for realizing the invention such as shown in FIG. 2 requires a remote control 14 and an electronic device 18 connected to a television screen 12. This device 18 can be a DVD player, satellite receiver, digital recorder, etc., more commonly called by those skilled in the art a “CE Device”; as already mentioned hereinabove.

When the user 16 with his hand 17 lightly touches the keypad 13 of the remote control 14 (Selection phase), the keypad 13 of the remote control 14 is displayed on the screen as a superimposure with the position of the thumb 15.

If the user 16 moves his thumb 15 on the keypad 13 (still in Selection phase), the image of the thumb 15 displayed in the zone 10 on the screen moves from key to key 13a, 13b, 13c or on the cursor 13d according to the actual position of the thumb 15 on the remote control 14.

If the hand 17 of the user 16 presses on a key 13a or 13b or 13c or on a cursor 13d (Validation phase), the “CE Device” 18 performs the requested action by pressing on the means for detecting and locating 20 the thumb 15 of the user 16 placed on said keypad 13 as such allowing for the display on the television screen 12 of the keypad 13 of the remote control system 14 and of the position of the thumb 15.

As soon as the hand 17 of the user 16 removes its thumb 15 from the keypad 13, the zone 10 representing the keypad 13 on the screen 11 disappears.

Of course, the invention is not limited to the examples that have just been described and many adjustments can be made to these examples without departing from the scope of the invention.

1-8. (canceled)

9. A remote control system for remotely controlling, by a hand of a user, an electronic card connected to on of a television screen and a monitor, said remote control system comprising:
a keypad having a plurality of keys;
an onboard processor;
a system for transmitting signals intended for said electronic card;
the keypad having a means for detecting and locating a thumb of the user placed on said keypad for allowing a display on a screen of the remote control system and the position of the thumb, and the electronic card having the capacity to modify a function associated with each key of the remote control and to modify a pictogram superimposed on each key.

10. A remote control system set forth in claim 9, wherein the display on the screen of the keypad of the remote control system and of the position of the thumb occupies a zone of reduced size superimposed on an image on the one of the television screen and monitor.

11. A remote control system set forth in claim 10, wherein the zone of reduced size superimposed on the image on the screen is positioned in a corner of the screen so as not to hide a broadcast image.

12. The remote control system set forth in claim 9, wherein the keypad further has at least one cursor provided with system of detecting and of locating the thumb of the user placed on said at least one cursor, so as to allow a display on the screen of the cursor of the remote control system and the position of the thumb.

13. The remote control system set forth in claim 9, wherein the electronic card comprises an electronic processor and associated memory wherein are stored the image of the keypad of the remote control, a virtual image of a thumb and of pictograms characterizing the actions associated with each key, all being displayed in a zone of reduced size superimposed on the image on the screen when the user lightly touches the keypad of the remote control.

14. The remote control system set forth in claim 9, wherein the electronic card has the capacity of playing a sound sequence associated with each function when the user lightly touches a key in such a way that sound information supplements visual information provided by a pictogram.

15. A method of transmitting control signals using a remote control system controlled by a hand of a user intended for an electronic card connected to one of a television screen and a monitor, said method comprising the steps of:
lightly touching a key of a keypad of the remote control system so that said card displays said keypad with associated pictograms and a position of a thumb of the hand of the user on the lightly touched key, and displaying the keypad and the thumb position in a zone of reduced size superimposed on an image on the screen;
pressing the thumb on the lightly touched key for validating the action of the key;
lifting the thumb from the keypad so that said electronic card deletes the display of the zone of reduced size superimposed on the image on the screen.

16. The method of transmitting control signals set forth in claim 15, further comprising:
after lightly touching a key of the keypad of the remote control system, the user can move his thumb towards another key of the keypad, and said electronic card then displaying movement of the thumb towards said another key in the zone of reduced size superimposed on the image on the screen.
